(19) United States
(12) Patent Application Publication
(10) Pub. No.: US 2011/0238557 A1
(43) Pub. Date: Sep. 29, 2011

(54) Method of Routing Instant Messages to Trading Customers and Converting Return Instant Messages into Executable Orders

(75) Inventor: Michael Barry, Homer Glen, IL (US)

(73) Assignee: MEB OPTIONS, INC., Chicago, IL (US)

(21) Appl. No.: 13/073,659

(22) Filed: Mar. 28, 2011

Related U.S. Application Data
(60) Provisional application No. 61/317,821, filed on Mar. 26, 2010.

(51) Int. Cl. G06Q 40/00

(52) U.S. Cl. 705/37

(57) ABSTRACT

A filter method of routing instant messages to customers and converting return instant messages into orders is disclosed for facilitating electronic trades of stock, stock options and other investment products. The filter method provides a step of generating a relational database of customer data, generating filter rules based on the customer, underlying stock and options data, selecting customers to receive a real-time trading data based on the filter rules, routing personalized instant messages to the selected customers, and converting return instant messages into executable orders. The filter method further serves as a platform from which other services, such as billing, auditing and logging, may extend to provide a complete business solution to its users.

### CROSS-REFERENCE TO RELATED APPLICATION

This application is a non-provisional application claiming the priority benefit under 35 U.S.C. 119(e) of U.S. provisional application Ser. No. 61/317,821, filed on Mar. 26, 2010.

### BACKGROUND

1. Technical Field

An improved method for transmitting data to trading customers is disclosed. More specifically, a method is disclosed for automatically routing instant messages containing real-time trading data to select customers and converting return instant messages into executable orders.

2. Description of the Related Art

Trading stock options and other securities can be complicated, risky and extremely time sensitive. Economic news or information relevant to an underlying stock or company can dramatically affect the price of the stock in a manner of minutes. Such relevant economic information is in even greater impact on the price of a stock option. Accordingly, successful traders must be able to react quickly to changes in the market, economic conditions and economic news.

One factor that inhibits a quick reaction to market news is the customer-broker relationship. Specifically, the customer, i.e. the trader or investor, works with a broker to execute an order, such as an order to buy or sell one or more stock option contracts. Because the customer and the broker are separate entities, and because the broker is provided with limited authorization to act on behalf of the customer, the order to buy or sell must typically be communicated from the customer to the broker. Because brokers work for many customers at a given time, fast and orderly communication between the customer and the broker can be problematic, particularly when the overall market or a particular stock is being affected by significant economic news.

Further, the typical options investor or customer has a number of positions simultaneously and therefore can simultaneously trade a number of different option contracts. More specifically, the customer normally provides the executing broker with a document or a spreadsheet of the customer's trading portfolio or products of interest to the customer. The broker then uses the portfolio to solicit business from the customer based on the customer's strategy or products in the customer's portfolio. Most of the time, the floor broker simply maintains the customer portfolios at the trading desk and refers to them as the activity in any particular product increases. Compounding this problem is the large number of option root symbols that are used. For example, NASDAQ stock symbols have four letters while options contracts on NASDAQ stocks have only three letters (MSFT is the NASDAQ stock symbol for Microsoft while MSQ is the root option symbol for option contracts on Microsoft stock. Stock splits also can create standard and non-standard option contracts and the use of still more root symbols. As a result of the complex portfolios held by typical customers and the large number of option root symbols, it is extremely difficult to monitor the trading activity of products held by a customer or desired by the customer. Accordingly, brokers continually struggle to find a system that enables them to quickly match their customers with the appropriate option root symbols and the associated underlying products.

Spreadsheet tools, such as Microsoft Excel, continue to be used by brokers for sorting through the various stock symbols and underlying option root symbols. Microsoft Access has also been used to correlate customer-product data. Although an improvement, spreadsheets and Microsoft Access databases are still cumbersome to use, have poor search functions, and require experienced personnel to input updates to customer and stock options data. Further, Microsoft Access databases can become unstable as the amount of data increases, and there is a lack of integration of customer billing data with customer trading data.

Third-party instant messaging applications are currently used to quickly communicate real-time trading data to groups of customers at a time. However, the majority of the transmitted instant messages and their contents were impersonal, unrelated to the customers' interest, or include irrelevant data. As a result, many customers simply ignore and/or block such instant messages as spam, which renders useless what could be an extremely useful communications tool.

Therefore, there is a general need for a solution which automatically manages relational customer data, associates each customer with a preferred set of stock option contracts or other preferred products, and efficiently relays real-time trading or market data to each and every customer of interest in the form of a show, or a proposed trade based on the transmitted real-time trading or market data. More specifically, there is a need to generate a scalable relational database that is easy to update and manage, generate smart filter rules to group customers according to their stock preferences, automatically select customers based on real-time trading data, and route personalized instant messages to the selected customers in the form of a show or a proposed trade as opposed to the current system, which relies on telephonic communications or vague and generalized instant messaging. Furthermore, there is a need for a system that can be extended or expanded upon to provide additional services, such as converting return instant messages into orders, automatically executing transactions, updating billing data, and the like.

While the following discussion will be directed toward improved methods of automatically routing stock option contract quotes to select customers, it will be noted that this application and the methods disclosed herein are applicable to various fields beyond those related to stock options, and more generally, can be applied to any order or transaction executable online or in an electronic form.

### SUMMARY OF THE DISCLOSURE

In satisfaction of the aforenoted needs, a filter method of routing instant messages to customers and converting return instant messages into executable orders is disclosed.

A method of routing instant messages to customers is disclosed. The method includes the steps of generating a relational database of customers, generating filter rules for each customer based on the data associated with each customer contact, associating the instant messages with real-time data, forming a list of customers to receive the instant messages based on the filter rules, and routing the instant messages to the selected customers. The relational database comprises customer data including contact information and preferences of each customer or each contact of each customer, if a “customer” includes more than one individual contact.

In a refinement, the preferences include preferences related to underlying stock volume, option series, option series volume, option series bid price, option series ask price, status of the trade or order indicated by color and whether the order represents a reverse conversion (e.g., simultaneous short sale of stock, sale of a put option and purchase of a call option).

In another refinement, the step of forming a list of customers is automated.

In another refinement, each of the instant messages is configured to be sent from a respective representative of each of the selected customers.

In another refinement, the method further includes a step of enabling the customers to electronically respond to the instant messages. In a related refinement, the method further includes a step of electronically converting responses into executable orders. In another related refinement, the method further includes a step of updating the data associated with responding customers. In yet another related refinement, the method further comprises a step of providing each responding customer with a summary of the order.

Another method of routing instant messages to customers, which further converts return instant messages into orders, is disclosed. The method includes the steps of generating a relational database of customers, providing each customer personnel or individual access to the data associated with the customer, generating filter rules for each customer contact based on the data associated with the customer contact, associating the instant messages with real-time pricing information for a product, forming a list of customers to receive the instant messages based on the filter rules, configuring each of the instant messages to be sent from a respective representative of each selected customer contact, routing the instant messages to the selected customers, enabling the customers to electronically respond to the instant messages, electronically converting responses into executable orders, updating the data associated with responding customers, and providing each responding customer contact with a summary of the order. The relational database comprises customer data including contact information and preferences of each customer.

A method of routing a show to a customer, or a proposed trade based on real-time trading data of interest to the customer, is disclosed. The method includes the steps of generating a relational database of customers, providing each customer personnel or individual access to the data associated with the customer contact, generating filter rules for each customer contact based on the data associated with the customer contact, forming a list of customers to receive the show based on the filter rules, configuring each of the shows to be sent from a respective representative of each selected customer contact, and routing the show to the selected customers.

In another refinement, the method further includes a step of enabling the selected customers to electronically respond to the show. In a related refinement, the method further includes a step of electronically converting responses to the show into an executable order. In a related refinement, the method further includes a step of updating the data associated with customers that respond to the show. In yet another related refinement, the method further includes a step of providing each responding customer with a summary of the order.

In yet another refinement, the method further includes a step of logging the transmitted shows and responses to the shows.

Another method of routing shows to customers, which also converts responses to the shows into orders, is disclosed. The method includes the steps of generating a relational database of customers, providing each customer personnel or individual access to the data associated with the customer contact, generating filter rules for each customer contact based on the data associated with the customer contact, forming a list of customers to receive the shows based on the filter rules, configuring each of the shows to be sent from a respective representative of each selected customer contact, routing the shows to the selected customers, enabling the selected customers to electronically respond to the shows, electronically converting responses to the shows into orders, updating the data associated with responding customers, and providing each responding customer contact with a summary of the order.

Other advantages and features will be apparent from the following detailed description when read in conjunction with the attached drawings.

### BRIEF DESCRIPTION OF THE DRAWINGS

FIG. 1 is a flow chart of an exemplary filter method of routing instant messages to customers and converting return instant messages into orders in accordance with this disclosure;

FIG. 2 is a diagram of a system incorporating the filter method of FIG. 1;

FIG. 3 is a login interface for a server managing a relational database;

FIG. 4 is an interface for managing customer firm data;

FIG. 5 is an interface for managing customer contact data;

FIG. 6 is an interface for managing customer contact details;

FIG. 7 is a detailed view of the Tools menu;

FIG. 8 is an interface for managing stock preferences;

FIG. 9 is a hierarchical diagram of a relational database;

FIG. 10 is an interface for managing shows;

FIG. 11 is an interface for viewing logged shows; and

FIG. 12 is an interface for managing distribution lists.

In the drawings, details which are not necessary for an understanding of this disclosure or which render other details difficult to perceive may have been omitted. It should be understood, of course, that this disclosure is not limited to the particular methods and embodiments illustrated in the figures and described herein.

### DETAILED DESCRIPTION OF THE PRESENTLY PREFERRED EMBODIMENTS

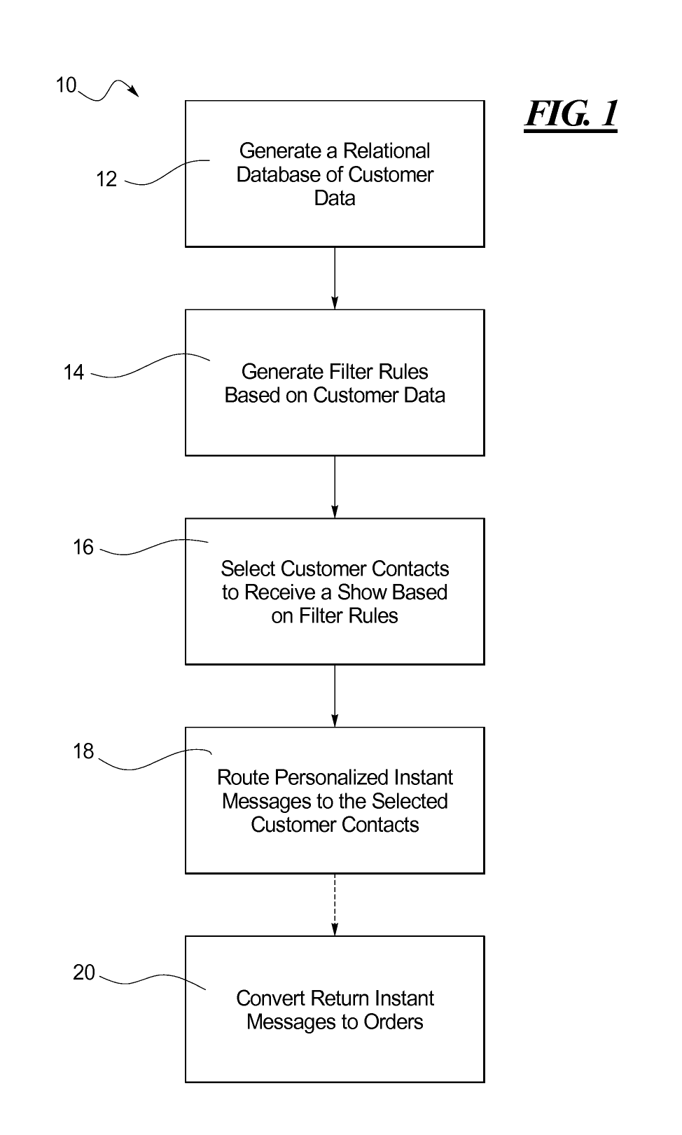

The flow chart of FIG. 1 illustrates an exemplary filter method 10, or a method of routing instant messages to customers and converting return instant messages into executable orders. In particular, the filter method 10 may be employed by users, such as sellers, brokers, or the like, to efficiently communicate real-time trading data or shows to a larger number of select customers and/or one or more personnel of a given customer. As more customers or potential buyers are made aware of a new show or quote, more customers are likely to buy the product or stock at the quoted price while it is still in effect. As illustrated in FIG. 1, the filter method 10 may include the steps of generating a relational database of customer data 12, generating filter rules based on the customer data 14, selecting customers to receive a show based on the filter rules 16, routing personalized instant messages to the selected customers 18, and converting return instant messages into orders 20. Although the disclosed method 10 is directed toward presenting customers with real-time trading data, the filter method 10 may also be adapted for use with executing any other online or electronic transactions. Depending on the particular application, the filter method 10 of FIG. 1 may include fewer or more steps than shown.

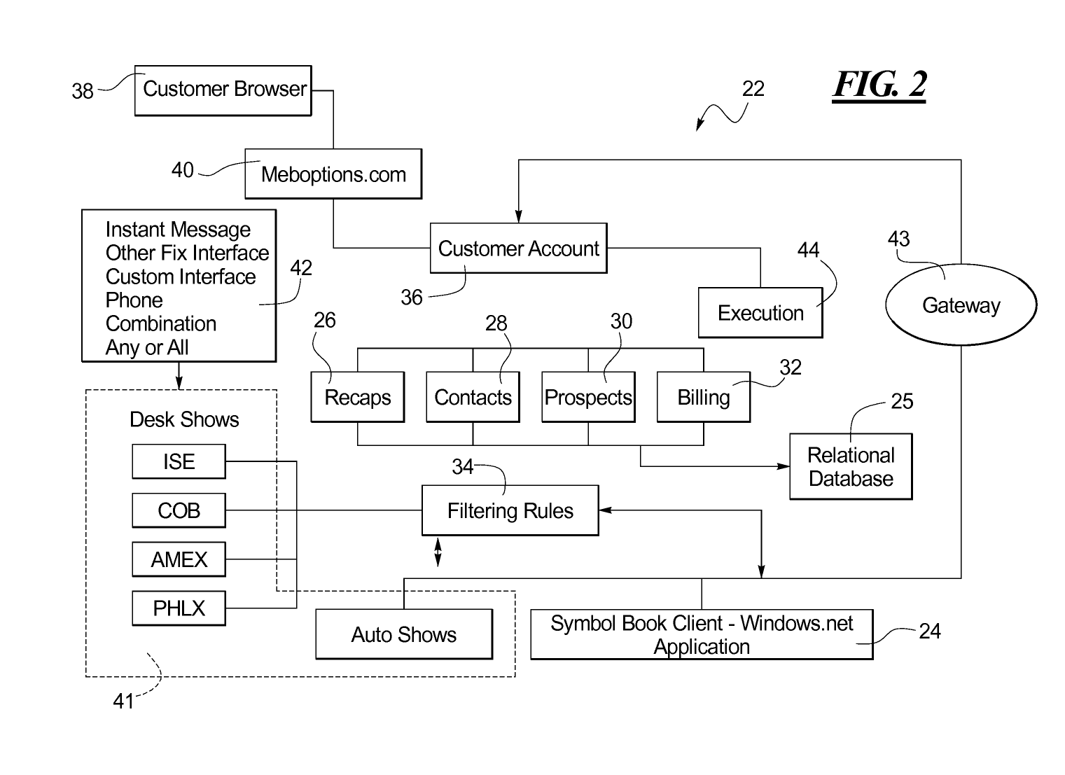

Turning to the diagram of FIG. 2, an exemplary system 22 incorporating the filter method 10 of FIG. 1 is provided. Specifically, the filter method 10 may be encoded as software and run as a business application 24 on a user's computer, server, database, or the like. The application 24 may be used in conjunction with a relational database 25 which stores, updates and manages various information related to a user's customers or customers within a firm, such as trading history 26, contact information 28, prospect information 30, billing information 32, and the like. The application 24 may further sort the customer contact data and create filter rules 34 based on the data. Additionally, the application 24 may be adapted to maintain a customer account 36 for each customer firm or customer, which may be accessed by the contact at any time using a connection to the internet, or the like. More specifically, customers may access their accounts 36 using an internet browser 38 and by browsing to a company website 40 hosted by the user. Using such access, customers are able to view or modify their online profiles, stock preferences, contact information, past transactions, recent trades, and the like. As licensed owners of the filter system 22 and application 24, a user and representatives employed by the user may also have access to customer accounts 36. The application 24 may also be configured to automatically sort and update any changes made by the customers, and incorporate the changes into the filter rules 34 accordingly. Most importantly, the application 24 may be configured to automatically detect a new show 41, and use the filter rules 34 to gather the instant messaging names of all customers who expressed an interest in the particular show 41. A show 41 may be provided in any one of a variety of different communication interfaces and means 42 and may include valuation shows and/or automated shows. A valuation show may include market data that is fed directly from one or more exchanges, for example, the Chicago Board Options Exchange (CBOE), the International Securities Exchange (ISE), and the like. Valuation shows may be provided by monitoring active option spreads or complex orders and making evaluations of those orders or spreads. The evaluations may include, for example, determining whether the spread meets predefined filtering rules or worth further review, determining the theoretical value of the spread, and the like. If the spread is determined to be worthy, it may be forwarded to a broker for further review. Upon review, a floor broker may determine whether the spread would be of interest to a particular customer, and if so, communicate the show 41 to the customer. An automated show may be similar to a valuation show but distinct in that it is automatically generated. More specifically, an automated show may be provided by automatically monitoring market data feeds, automatically selecting shows 41 matching the interest of customers, and automatically transmitting the shows 41 to target customers based on predefined filtering rules 34. An automated show may be communicated to a customer based on, for example, the minimum or maximum quantity of shows 41 preferred by the customer, and whether the customer prefers only positive edge shows, mid market shows or shows anywhere in the middle of the market.

Once a list of contacts has been formed, the application 24 may connect with an instant messaging gateway 43. Specifically, the gateway 43 may employ messaging interfaces or standards such as the Extensible Messaging and Presence Protocol (XMPP), and the like, in order to connect with an instant messaging service provider or network, obtain the necessary permissions, and route the instant messages containing the show 41 to instant messaging clients. As long as the customers who expressed interest in the show 41 are also connected to the gateway 43 and have instant messaging clients installed on their respective computers, mobile devices, and the like, they will receive the show 41. Additionally, each customer account 36 may be provided with order execution means 44 such that, in order to take action on a particular show 41, a customer contact needs only to electronically respond to the message containing the show 41, and the contact's trading and billing history 26, 32 are updated accordingly.

Referring back to FIG. 1, the filter method 10 may include an initial step 12 of generating a relational database 25 of customer data. The relational database 25 may be implemented using a server, or other storage device, and may serve to store, sort and maintain information regarding customer firms, customers, products or stocks, and any other information that may be required for carrying out the functions of the filter method 10. More specifically, the relational database 25 may include customer contact and preference information, real-time data related to stocks, indexes, strikes, option symbols, leaps, instant messaging traffic, information related to the owner or user and representatives employed by the user, administrative information, and the like. The step 12 of generating the relational database 25 may further be extended to store billing information, such as billing rates, archived billing history for each customer, month-to-date billing information, invoices, payment history, and the like. The database 25 may also store relational information between customer firms and subgroups of traders or customers within the firms, instant messaging names of contacts, existing contact lists from third-party applications, any relevant trade notes, and the like.

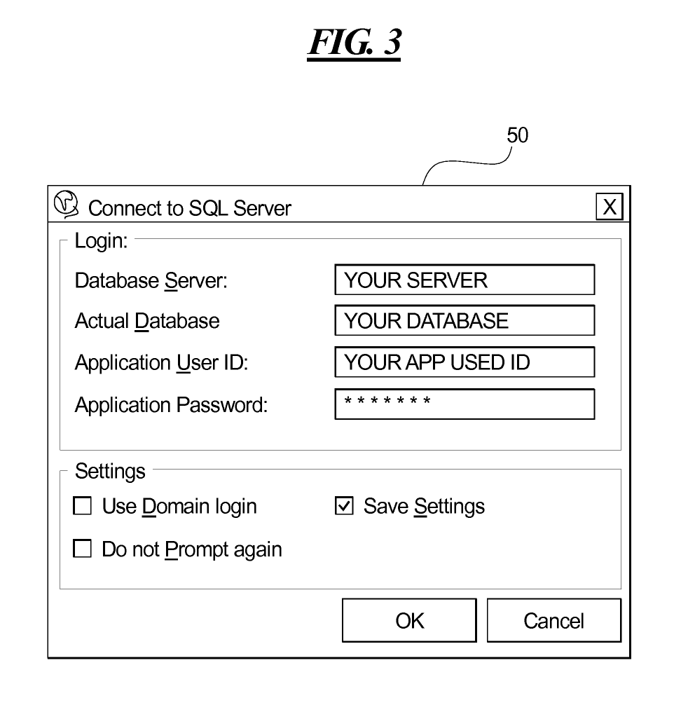

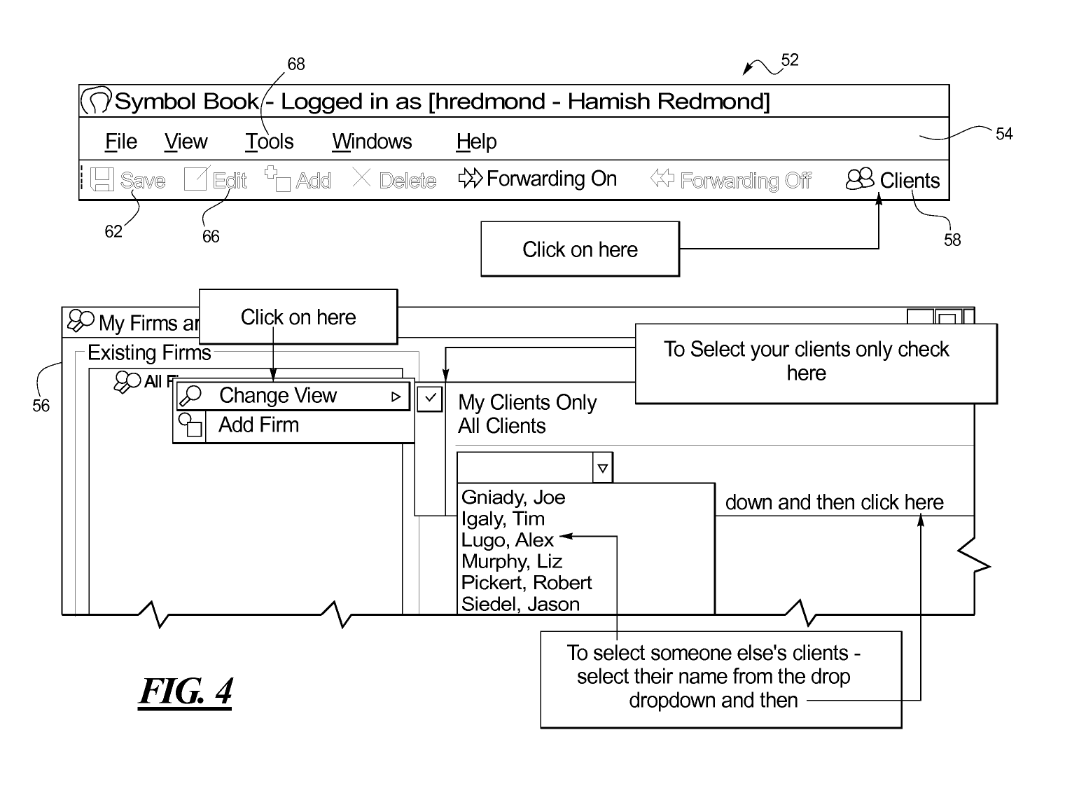

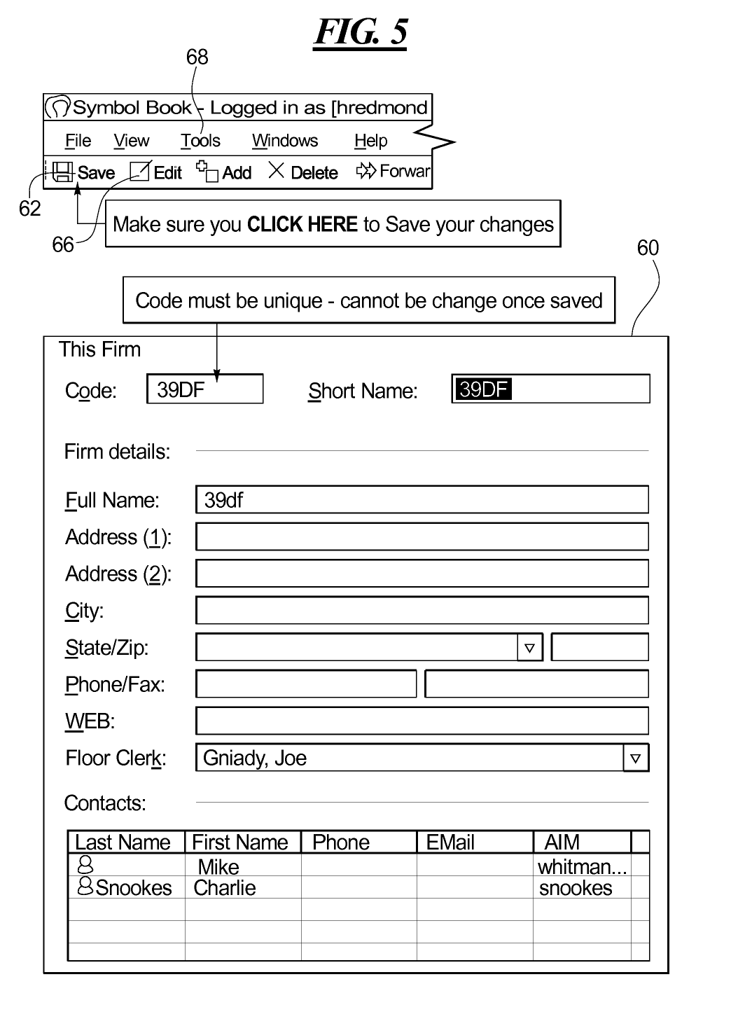

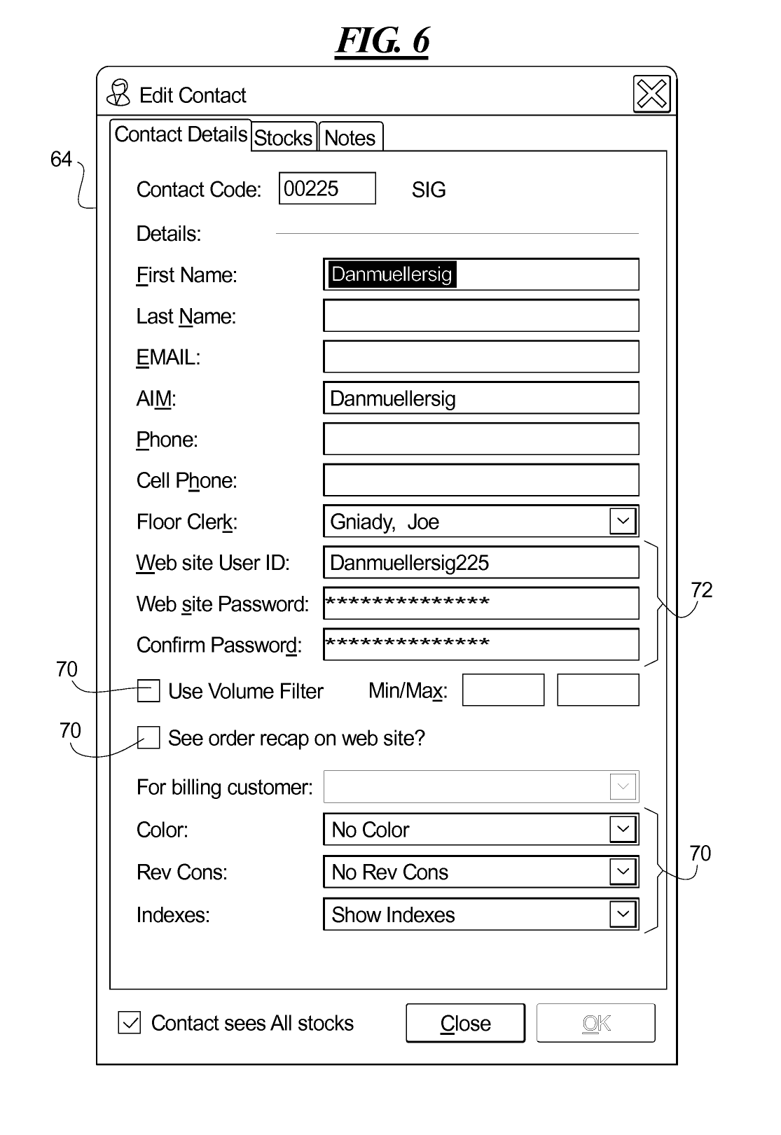

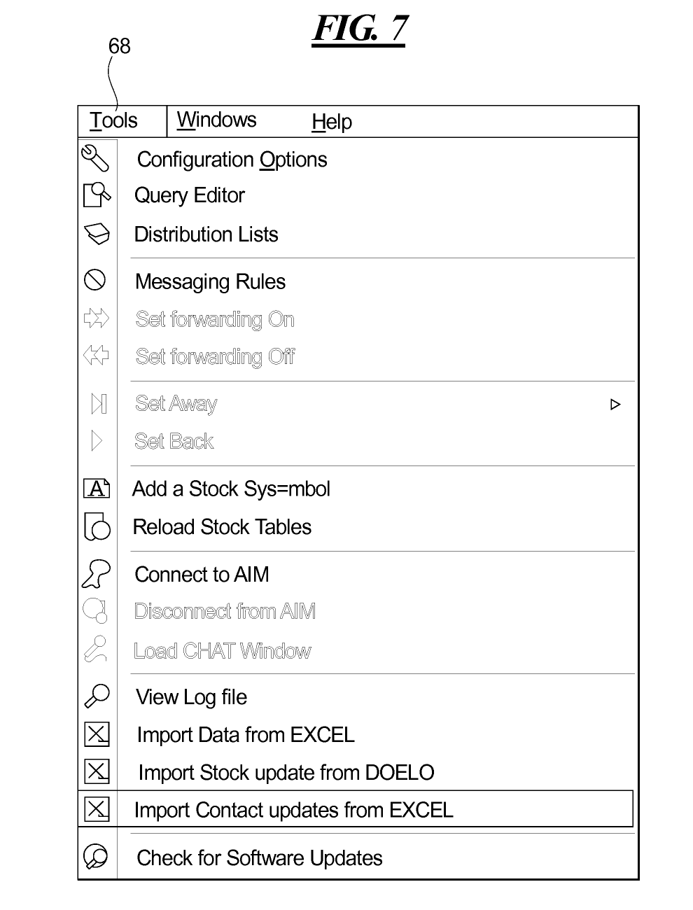

A user or a representative may access a relational database 25 by logging into an interface of the associated server, such as the SQL server interface 50 of FIG. 3. After logging into the server, a user may access and manage various data stored within the database 25 using, for example, the explorer interface 52 of FIG. 4. The explorer interface 52 may include a toolbar 54 and a window 56 for displaying information corresponding to the option selected from the toolbar 54. For instance, a user may select or click on the Clients (customer) option 58 of the toolbar 54 to open a window 56 listing all of the current customer or client firms, individual contacts within each firm, and the like. Information related to each firm, such as the firm's address, telephone number, website address, representative or floor clerk representing the firm, and the like, may be created or modified in successive displays 60 as shown in FIG. 5. Any modifications to the information shown may be saved by selecting the appropriate Save option 62 from the toolbar 54 shown. Furthermore, information related to each customer contact within a firm may be created or edited using the contact displays 64 of FIG. 6. Contact displays 64 may be accessed, for example, by highlighting the name of the contact's firm from the window 56 of FIG. 4 and clicking the appropriate Edit option 66 from the toolbar 54, or alternatively, by right-clicking on the name of the firm from the window 56 and selecting the appropriate option from a resulting pop-up menu. Such displays 60, 64 may allow the customers to enter and modify various account information, for example, contact name, email address, instant messaging name, telephone number, representative or floor clerk representing the contact, login information for accessing the specific account, and the like. Alternatively, an existing list of customer firms or customers may be imported or uploaded by selecting the appropriate command under the Tools option 68 from the toolbar 54 as shown in FIG. 7. Stock preferences 70 of a customer contact may also be created or modified in the display 64 of FIG. 6. Available stock option preferences 70 may include a volume filter, a color filter (indicating trade status), a reverse conversion indicator filter, an index filter, and the like. Once an account has been created for a contact, the account may be accessed from the user's company website using the contact's login credentials 72 created in the display 64 of FIG. 6.

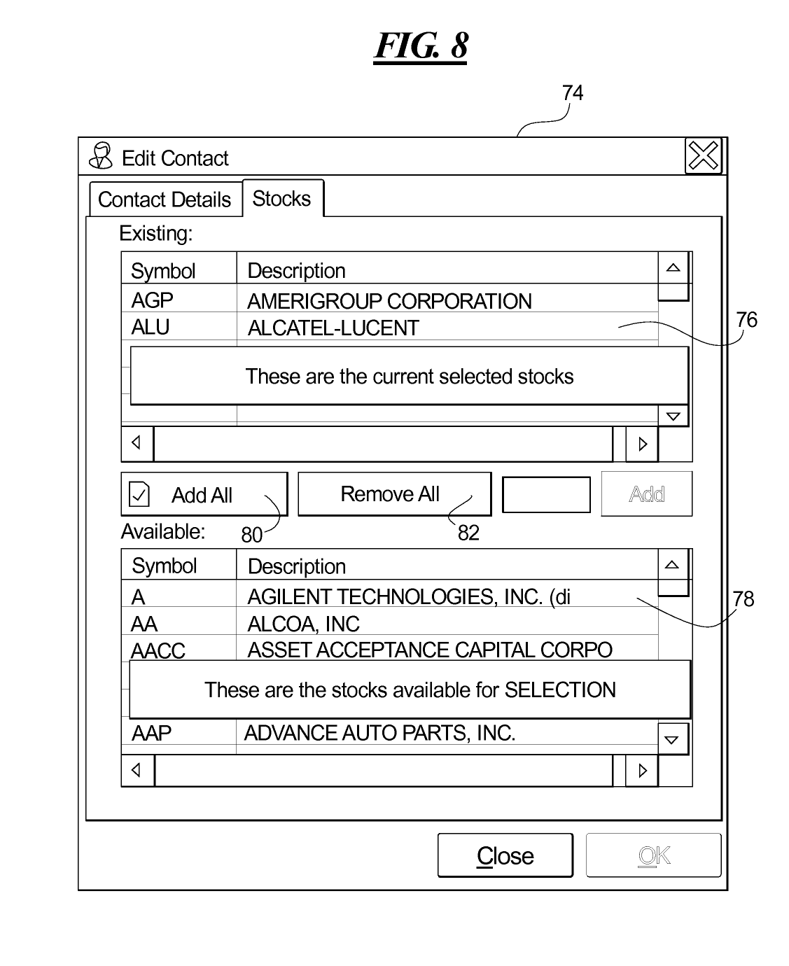

In addition to selecting stock preferences 70 as shown in FIG. 6, a contact may select specific stock symbols of interest in a separate display 74 as shown in FIG. 8. In particular, the display 74 may include an existing list 76 and an available list 78 of stock symbols. A contact may select or double-click on a stock symbol of interest from the available list 78 to add the symbol to the existing list 76. A customer may also remove a stock symbol from the existing list 76 by double-clicking the unwanted symbol. Furthermore, the Add All button 80 may be used to add all of the symbols from the available list 78 to the existing list 76, and the Remove All button 82 may be used to remove all of the symbols from the existing list 76. As shown in FIG. 7, a customer may also select the Tools option 68 to import or upload an existing list or spreadsheet of preferred symbols. Once all stock preferences 70 have been entered and stored in the relational database 25, filter rules specific to each customer may be generated.

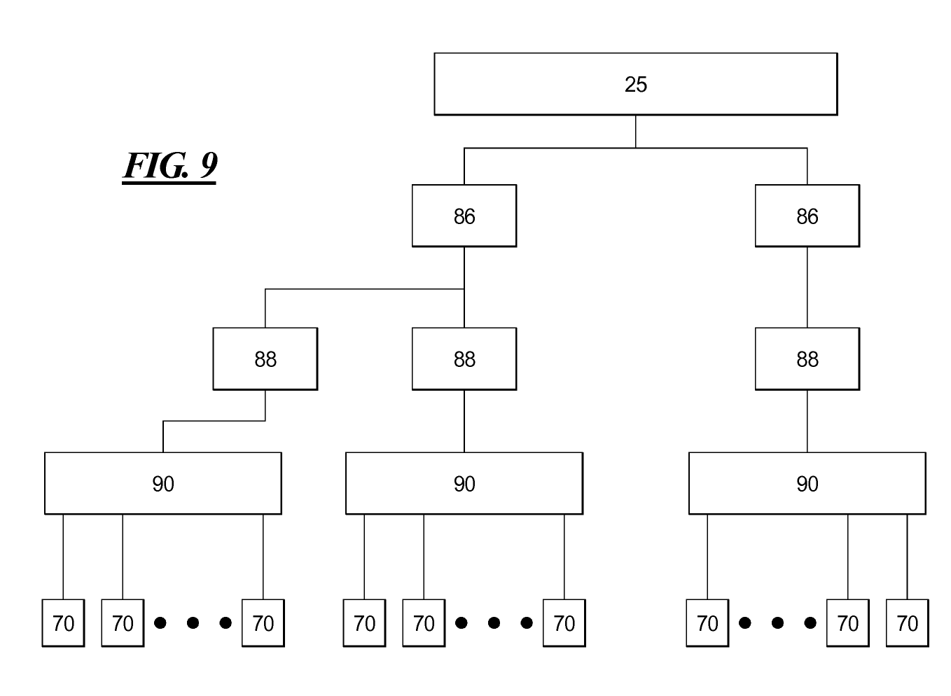

After generating a relational database 25, filter rules may be generated in a subsequent step 14 based on the stock preferences 70 previously provided by each customer contact. While other hierarchical structures are possible, an exemplary hierarchical diagram of a relational database 25 storing firm data 86 and customer contact data 88 is provided in FIG. 9. For example, the relational database 25 of a user may store one or more customer firms 86 at the top of the hierarchy. A list of individual contacts 88 within each firm 86 may be stored at a level beneath the list of firms 86, and the group of preferences 70, or filter rules 90, selected by each contact may be stored at a level beneath the list of contacts 88 of each firm 86. The filter rules 90 of FIG. 9 include preferences 70 pertaining to stocks, such as volume or contract size, color, reverse conversion and index. However, the filter rules 90 may also include any other classifications and/or preferences that may help personalize interactions with a contact, for example, the names of the representative representing the particular contact, the technology or industry sector, expirations, the selected Greeks and volatility, and the like. By associating filter rules 90 with such a relational database 25, the filter method 10 ensures that each contact only receives trade information related to the contact's stock of interest. Contacts who wish to modify their preferences 70 can do so by simply logging into their account through the user's company website, and the relational database 25 will automatically update the preferences 70 accordingly.

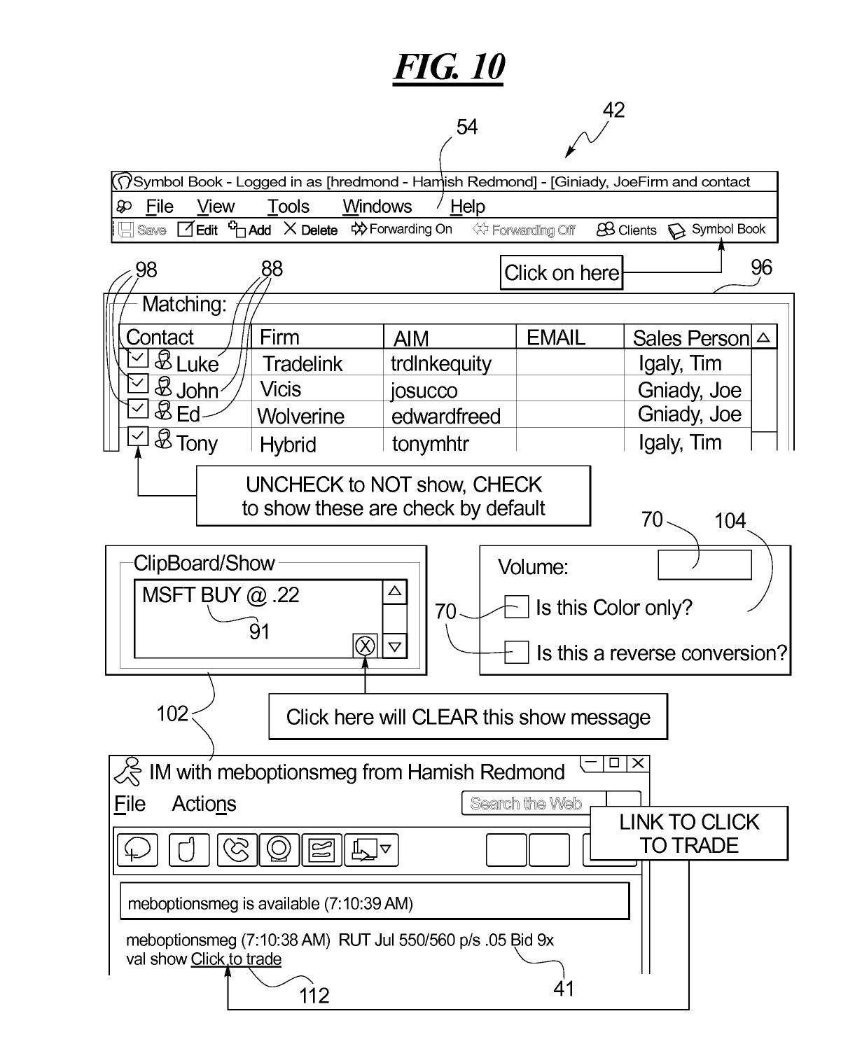

Once the filter rules have been established, contacts are automatically selected according to a show 41, or real-time trading data pertaining to a specific stock symbol, as in step 16 of FIG. 1. Specifically, to distribute a new show 41, a user or representative may employ the filter method 10 to scan through the filter rules and automatically select contacts whose preferences 70 coincide with the show data. To begin the scan, a user may select the Symbol Book option 94 from the toolbar 54, as shown in FIG. 10, and enter the desired symbol, option symbol or leap to automatically display a list of matching contacts 96. The desired symbol, option symbol or leap may be entered by typing the relevant strings into an input box, or by copying text from another open application running on the user's computer. Furthermore, the application may be configured to automatically detect the symbol, option symbol or leap from the typed or copied string of characters and display the list of matches 96 accordingly. Each contact in the resulting list of matches 96 may be selected or unselected using a checkbox 98, or the like.

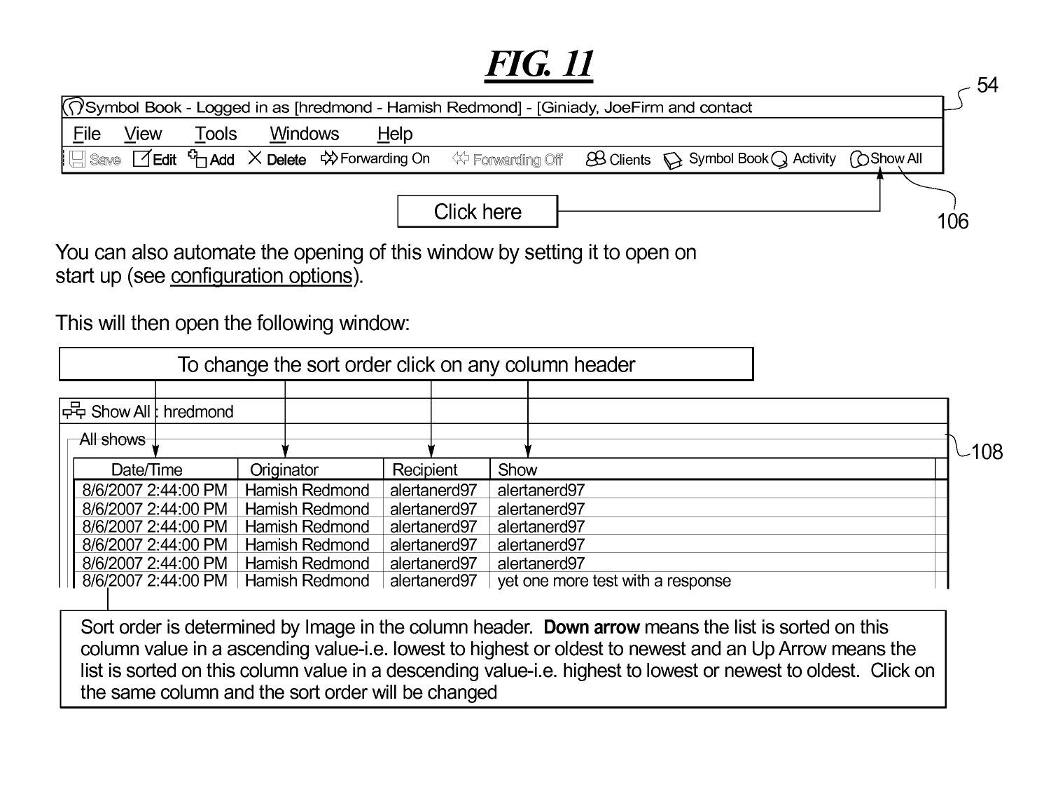

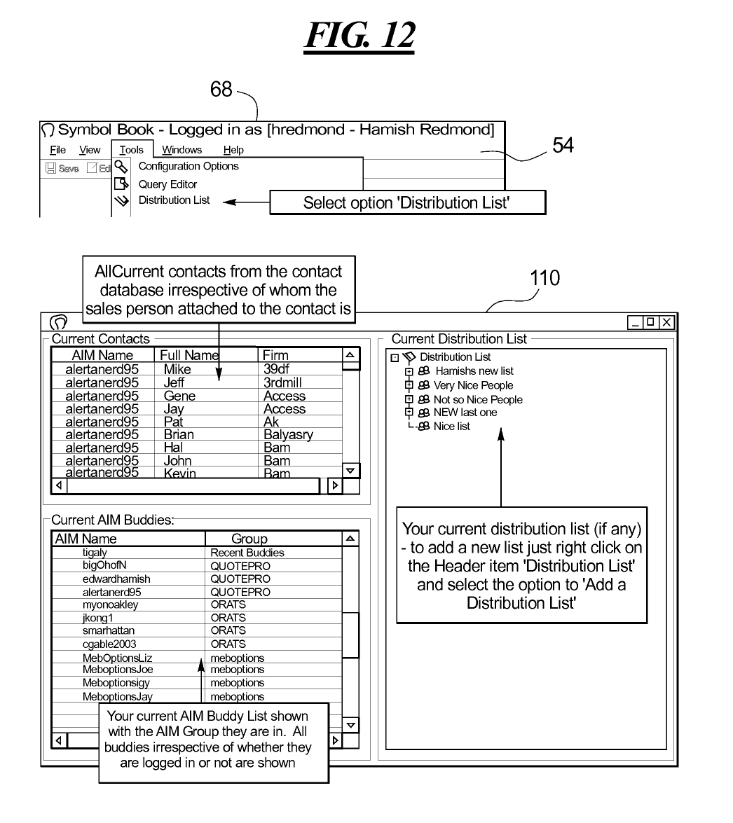

Once the selection of contacts is complete, an instant message may be routed to the selected contacts in a subsequent step 18. Still referring to FIG. 10, trading data or a show 41 may be entered into a message box 102 and transmitted to the selected contacts. The message box 102 may also provide an options box 104 to provide additional filtering based on volume, color, reverse conversion, and the like. The list of matching contacts 96 may be configured to automatically update the selection of contacts according to any changes to the filter strategy introduced by the options box 104. Once the show 41 is ready for distribution, the show 41 may be transmitted to the selected contacts by way of instant messaging applications, such as AIM, ICQ, MSN Messenger, Yahoo Messenger, Trillian, PIDGIN, or the like, as described by the system 22 of FIG. 2. Furthermore, each transmitted instant message may be routed through a user or a representative that is representing the contact. This step of rerouting instant messages ensures that the instant messages are not blocked by instant messaging applications as being sent from unknown senders, and further, ensures that the instant messages are not ignored or discarded by the recipient or customer contact as being related to advertisements, junk or spam. To view a record of the transmitted instant messages, a user may select the Show All option 106 from the toolbar 54 as shown in FIG. 11. The resulting show list 108 may display the originator, the recipient, the date and time of each transmission, and the like. Additionally, multiple copies of a show 41 may be broadcast to select groups of contacts using distributions lists. To create or manage distribution lists, a user may select the appropriate command under the Tools option 68 from the toolbar 54 of FIG. 12 to open the corresponding interface 110 shown. Using the interface 110, a user may add or remove contacts from each distribution list, or create groups according to user or customer preferences. By selecting one or more distribution lists, a user may broadcast a show 41 to a predetermined group of contacts without requiring additional filtering or selections.

In addition to routing instant messages, the filter method 10 may also convert return instant messages into orders, such as in step 20 of FIG. 1. For example, after routing an instant message, for example, the message box 102 of FIG. 10, containing a show 41 to contacts, the filter method 10 may also enable execution of trades or orders electronically. As illustrated in FIG. 10, the message box 102 may include hypertext or a clickable link 112 which redirects customers to the user's company website to complete the trade. More specifically, a subsystem of the filter method 10 which enables the click to trade link 112 may be based at least partially upon, for example, a certified FIX order routing connection to one or more exchanges associated therewith. Each customer may be preconfigured to receive messages 102 having click to trade links 112. Each preconfiguration may include a series of customer details or information which must be cleared before the customers are able to receive the messages 102 having the click to trade links 112. For instance, the customer details may include clearing member information, account codes, as well as risk management options, such as the maximum single contract size, the maximum daily quantity, and the like. Once all of the required customer details have been cleared, a message box 102 providing a show 41 as well as a click to trade link 112 may be transmitted to the respective customer. Upon clicking on the link 112, the customer may be redirected to the user's company website where the customer may review, cancel or execute the trade. The trade may be executed as long as the trade is still available or at least some of the quantity still remains. If the customer elects to execute the trade, the user's application, for example, a user-specified FIX engine, may be used to build and transmit an order execution request to the associated exchange. The associated exchange may then generate a response as to whether the trade was successfully executed. Based on the response provided by the exchange, the filter method 10 may additionally be configured to automatically generate messages, emails, or the like, to be transmitted to the customers and updating the customers on the status of the trade. In alternative embodiments, the filter method 10 may be configured to automatically detect from a contact's text response to an instant message whether the contact wants to buy, sell, or the like, and provide the contact with automated instructions for completing the order. The filter method 10 may also provide other measures for electronically verifying the identity of an online contact and automatically completing safe transactions all from within the instant messaging application.

The filter method 10 of FIG. 1 may serve as a platform from which other services may extend, and thus, may be modified and/or expanded upon to provide a complete business solution. For example, the filter method 10 may provide billing support, such as generating printable invoices, storing and displaying payment history, and the like. Additional services may include steps of automatically updating a contact's order and billing history. The updates may be accessible to contacts by way of the relational database 25 and a user's company website hosted by the relational database 25. The filter method 10 may also provide search functionality and scan the relational database 25 for a search term submitted by a user. More specifically, an integrated search engine may search customer firms, customers or contacts, symbols, preferences, keywords, or the like, for possible matches to the search term. The filter method 10 may further provide measures for logging instant messages between users and customers, and measures for auditing bills and transactions stored within the relational database 25.

While only certain embodiments have been set forth, alternatives and modifications will be apparent from the above description to those skilled in the art. These and other alternatives are considered equivalents and within the spirit and scope of this disclosure and the appended claims.

1. A method of routing instant messages to customers, comprising:
generating a relational database of customers, the database comprising customer data including contact information and preferences of each customer;
generating filter rules for each customer based on the data associated with each customer;
associating the instant messages with real-time trading data;
forming a list of customers to receive the instant messages based on the filter rules; and
routing the instant messages to the selected customers.

2. The method of claim 1, wherein the filter rules include preferences related to underlying stock volume, option series, option series volume, option series bid price, option series ask price, status of the trade or order indicated by color and whether the order represents a reverse conversion.

3. The method of claim 1, wherein the step of forming a list of customers is automated.

4. The method of claim 1, wherein each of the instant messages is configured to be sent from a respective representative of each selected customer contact.

5. The method of claim 1 further comprising a step of enabling the customers to electronically respond to the instant messages.

6. The method of claim 5 further comprising a step of electronically converting responses into orders.

7. The method of claim 6 further comprising a step of updating the data associated with responding customers.

8. The method of claim 7 further comprising a step of providing each responding customer with a summary of the order.

9. A method of routing instant messages to customers and converting return instant messages into orders, comprising the steps of:
generating a relational database of customers, the database comprising customer data including contact information and preferences of each customer contact;
providing each customer individual access to the data associated with the customer;
generating filter rules for each customer based on the data associated with the customer contact;
associating the instant messages with real-time pricing information for a product;
forming a list of customers to receive the instant messages based on the filter rules;
configuring each of the instant messages to be sent from a respective representative of each selected customer contact;
routing the instant messages to the selected customers;
enabling the customers to electronically respond to the instant messages;
electronically converting responses into orders;
updating the data associated with responding customers; and
providing each responding customer with a summary of the order.

10. The method of claim 9, wherein the filter rules include preferences related to underlying stock volume, option series, option series volume, option series bid price, option series ask price, status of the trade or order indicated by color and whether the order represents a reverse conversion.

11. The method of claim 9, wherein the step of forming a list of customers is automated.

12. A method of routing shows to customers, comprising the steps of:
generating a relational database of customers, the database comprising customer data including contact information and stock preferences of each customer contact;
providing each customer individual access to the data associated with the customer contact;
generating filter rules for each customer based on the data associated with the customer contact;
forming a list of customers to receive the shows based on the filter rules;
configuring each of the shows to be sent from a respective representative of each selected customer contact; and
routing the shows to the selected customers.

13. The method of claim 12, wherein the filter rules include preferences relating to underlying stock volume, option series, option series volume, option series bid price, option series ask price, status of the trade or order indicated by color and whether the order represents a reverse conversion.

14. The method of claim 12, wherein the step of forming a list of customers is automated.

15. The method of claim 12 further comprising a step of enabling the selected customers to electronically respond to the shows.

16. The method of claim 15 further comprising a step of electronically converting responses to the shows into orders.

17. The method of claim 16 further comprising a step of updating the data associated with responding customers.

18. The method of claim 17 further comprising a step of providing each responding customer with a summary of the order.

19. The method of claim 12 further comprising a step of logging the transmitted shows and responses to the shows.

20. A method of routing shows to customers and converting responses to the shows into orders, comprising the steps of:
generating a relational database of customers, the database comprising customer data including contact information and stock preferences of each customer contact;
providing each customer individual access to the data associated with the customer contact;
generating filter rules for each customer based on the data associated with the customer contact;
forming a list of customers to receive the shows based on the filter rules;
configuring each of the shows to be sent from a respective representative of each selected customer contact;
routing the shows to the selected customers;
enabling the selected customers to electronically respond to the shows;
electronically converting responses to the shows into orders;
updating the data associated with responding customers; and
providing each responding customer with a summary of the order.
